(19) United States
(12) Patent Application Publication
(10) Pub. No.: US 2026/0275139 A1
(43) Pub. Date: Sep. 17, 2026

(54) Aqueous Ink Set for Inkjet Recording

(71) Applicant: Agfa NV, Mortsel (BE)

(72) Inventors: Hubertus Van Aert, Mortsel (BE); Jens Lenaerts, Mortsel (BE); Steven Lezy, Mortsel (BE); Céline Joie, Mortsel (BE)

(73) Assignee: Agfa NV, Mortsel (BE)

(21) Appl. No.: 19/167,928

(22) PCT Filed: Mar. 18, 2024
(86) PCT No.: PCT/EP2024/057147

§ 371 Date: Sep. 23, 2025

(30) Foreign Application Priority Data
Mar. 24, 2023 (EP) 23164057.4

(51) Int. Cl. C09D 11/40; B41M 3/00; B41M 5/00; C09D 11/322; C09D 11/54

(52) U.S. Cl. CPC C09D 11/40; B41M 3/001; B41M 5/0017; C09D 11/322; C09D 11/54

(57) ABSTRACT

An ink set for inkjet printing comprising an ink and an aqueous reaction liquid, the ink comprises water and a pigment, the aqueous reaction liquid comprises a dispersant, a polycarbodiimide according to Formula I, II, III or IV or a carbodiimde according to Formula V or VI. An inkjet recording method using this ink set onto non or low absorbing substrates is also included.

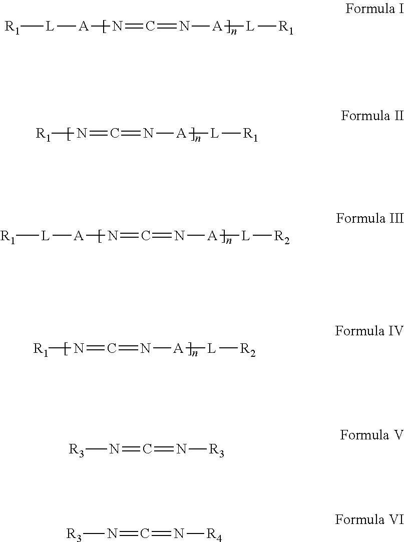

### TECHNICAL FIELD

The present invention relates to a water-based ink set for ink-jet printing, and an inkjet printing method.

### BACKGROUND ART

From the viewpoint of improving water resistance and weathering resistance of images obtained by means of inkjet printing, ink using not a dye but a pigment as a colorant have been proposed. However, when printing characters or images with pigment containing inks on a low-ink absorbing printing medium such as a coated paper or a resin film, pigment particles tend to remain on the surface of the printing medium after the printing. The pigment particles are likely to be peeled off from the printing medium by rubbing the images or by presence of water onto the images.

To meet these requirements, additional resins or polymers are integrated into aqueous ink jet inks which function as a binder. In several applications, the substrates used are temperature sensitive, limiting the drying and optionally curing temperatures that can be used. Depending on requirements for a specific application, different resin technologies, compatible with temperature sensitive substrates, have been disclosed in the prior art.

Latex based approaches have been disclosed in the patent literature (see WO2018/114314A, US 2013/0245157A1 and EP3275949A1), having binding capability to fulfil some requirements on physical properties for several applications. However, latex based inkjet inks do generally not improve simultaneously water resistance and rub resistance of printed images on low absorbing substrates such as corrugated card board or non-absorbing substrates. Furthermore, latex based ink jet inks have a tendency for film formation in the nozzles of the print head and in the ink supplies, leading to reliability problems during printing. In industrial applications, system reliability and especially jetting reliability is of utmost importance. Therefore, there was still a need for more optimal resin technologies.

In attempts to improve the friction resistance of such a pigment ink printed matter, for example, JP-2011-63016-A and JP-2011-105900-A disclose methods of protecting (fixing) the surface of a printed matter by applying a transparent post-processing fluid onto the recording medium after the image has been printed.

The easiest way to apply a transparent post-processing fluid onto a recording medium carrying an inkjet printed image is by over-all coating the post-processing fluid as in US2007/0282037A1.

Commercial analogue over-print varnishes are available. In that case, the amount of post-processing fluid is significantly more than if the post-treatment fluid in only applied onto the inkjet printed image. Moreover, change over times that are needed to switch between different paper sizes are significant and contribute to a less economically efficient printing process.

Therefore, it is beneficial to apply the post-treatment liquid only onto the inkjet printed image. The most suitable technique for image wise applying the post-treatment liquid is inkjet and only requires an extra inkjet head into the printing equipment.

EP3835376A discloses an ink set for ink-jet printing, containing an aqueous composition containing a carbodiimide compound and water, and a water-based ink containing a pigment and a vinyl polymer.

WO2022/046112 discloses a cross-linker composition including a linear polycarbodiimide and an aqueous cross-linker vehicle.

The polycarbodiimides disclosed in the above documents are preferably aqueous polycarbodiimide compounds from the viewpoint of stability and handling properties in an aqueous liquid. The aqueous polycarbodiimide compounds may be either water-soluble or water-dispersible. Therefore, the aqueous polycarbodiimide compounds include compounds containing a hydrophilic group at an endgroup end thereof, such as CARBODILITE V-02 (Nisshinbo Chemical Inc.). This water dispersibility or water-solubility, however, leads to a reduced mechanical resistance of printed images in a wet state.

Therefore, there is still a strong need for a post-treatment liquid which improves the mechanical resistance of printed images in a dry and wet state and which is very suitable to be printed by means of a jetting technique.

### SUMMARY OF INVENTION

It is the objective of the present invention to provide a solution to the above stated problems. The objective has been achieved by providing an ink set with an aqueous ink and an aqueous reaction liquid comprising a polycarbodiimide or carbodiimide and a dispersant as defined in claim 1.

It is another embodiment of the invention to provide a printing method using the ink set of claim 1 as defined in claim 10.

Other features, elements, steps, characteristics, and advantages of the present invention will become more apparent from the following detailed description of preferred embodiments of the present invention. Specific embodiments of the invention are also defined in the dependent claims

### DESCRIPTION OF EMBODIMENTS

### A. Ink Set for Inkjet Printing

The ink set for inkjet printing according to the invention comprises an aqueous inkjet ink and a reaction liquid. The ink contains water and a pigment, the reaction liquid comprises water, a polycarbodiimide or carbodiimide and a dispersant.

### A.1. Reaction Liquid

### Polycarbodiimide or Carbodiimide

The reaction liquid as part of the ink set according to the invention is used to protect the inkjet printed image against wet & dry rubbing, scratches, water and solvents. The reaction liquid therefor, comprises water, a dispersant, and a polycarbodiimide according to Formula I, II, III or IV or a carbodiimide according to Formula V or VI.

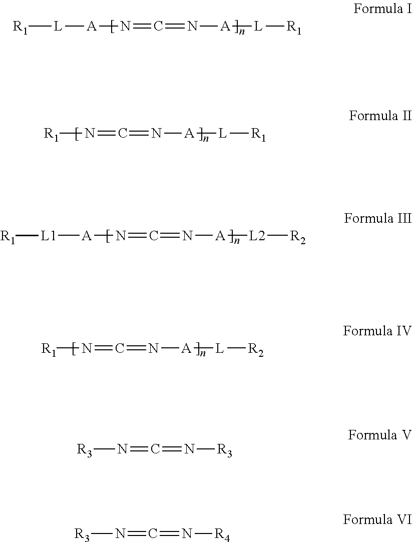

### Wherein

A is the group of atoms present between two isocyanate groups in a diisocyanate or polyisocyanate used in the preparation of the polycarbodiimide.
L, L1 and L2 is independently a divalent linking group selected from the group consisting of a substituted and unsubstituted urethane, a substituted and unsubstituted urea, a substituted and unsubstituted 2-oxazolidone, a substituted and unsubstituted carbodiimide, a substituted and unsubstituted amide, a substituted and unsubstituted acyl urea, a substituted and unsubstituted biuret.
R₁, and R³ independently are unsubstituted alkyl group, unsubstituted alkenyl group, unsubstituted alkynyl group, unsubstituted aryl or heteroaryl group, unsubstituted aralkyl group, unsubstituted alkaryl group, unsubstituted cyclo alkyl group.
R₂, and R⁴ independently are a substituted or unsubstituted alkyl group, a substituted or unsubstituted alkenyl group, a substituted or unsubstituted alkynyl group, a substituted or unsubstituted aryl or heteroaryl group, a substituted or unsubstituted aralkyl group, a substituted or unsubstituted alkaryl group, a substituted or unsubstituted cyclo alkyl group n is an integer having a value of 1 or higher. Preferably n is an integer from 2 to 10.

As an example of R₂ being a substituted alkyl, is the structure with CAS number 2762319-28-6 depicted in Table 2, in which R2 is an alkoxylated alcohol (for n=1) or a poly(alkoxylated) alcohol (for n>1).

In a preferred embodiment of the invention, A is selected from a group consisting of isophorone, 4,4′-dicyclohexylmethane, 2,4,4′-trimethyl-1,6-hexamethylene, hexamethylene, pentamethylene, tolylene, xylene, m-tetramethylxylene and diphenylmethane.

Without being bound by a theory, it is thought that the polycarbodiimide according to Formula I, II, III or IV or the carbodiimide according to Formula V or VI may crosslink with the resins present in the inkjet ink or reaction liquid leading to a crosslinked polymeric network. Because the carbodiimide does not comprise ethylene oxide moieties at both ends to be soluble or dispersible in an aqueous vehicle, the water resistance of the obtained images after drying is much improved.

Suitable commercially available polycarbodiimides or carbodiimides are Carbodilite E-05 from Nisshinbo Chemical according to Formula VI and Desmodur X2802 from Covestro, at least according to Formula III.

Other suitable polycarbodiimides having the same end capping R-groups are listed in Table 1.

TABLE 1

| Structure | CAS registry nr. |
|---|---|
| 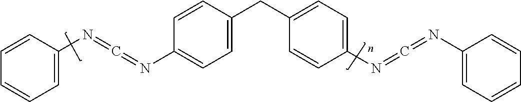 | 114402-95-8 |
| 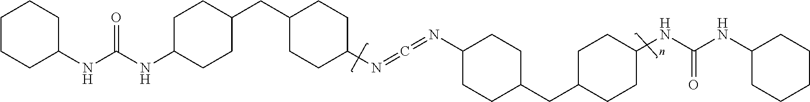 | 245550-08-7 |
| 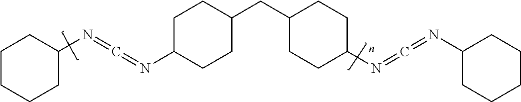 | 155224-16-1 |
| 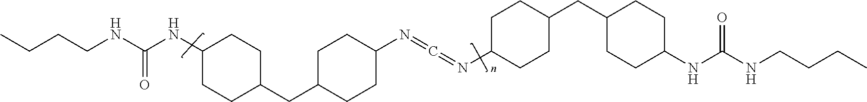 | 175075-18-0 |
| 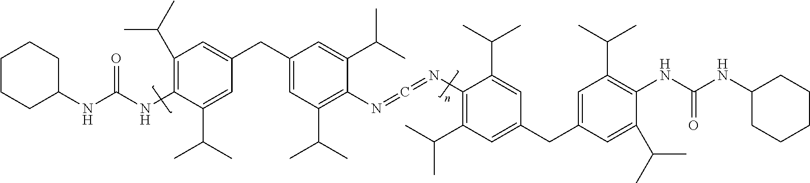 | 1922096-01-2 |
| 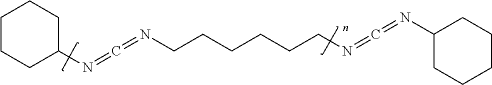 | 155224-17-2 |
| 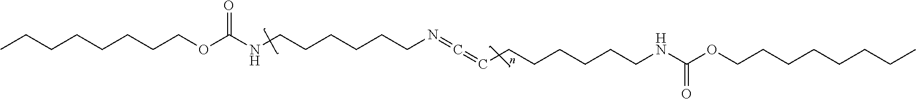 | 2762461-25-4 |
| 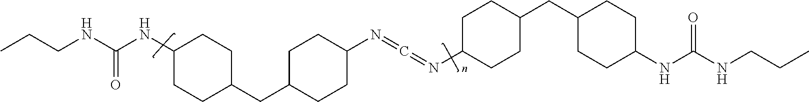 | 2416223-39-5 |
| 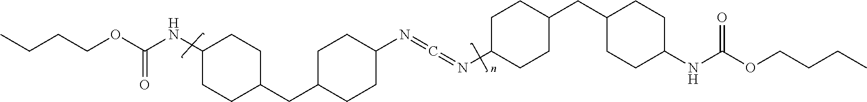 | 865087-92-9 |
| 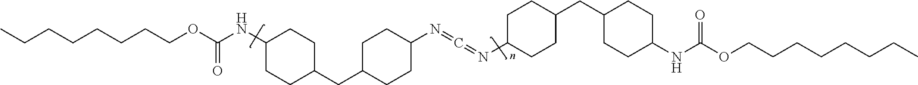 | 2483942-21-6 |
| 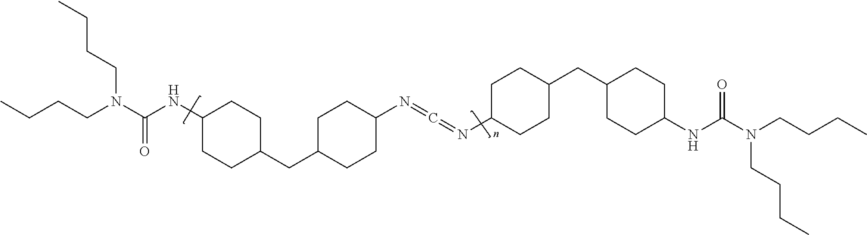 | 175075-19-1 |
| 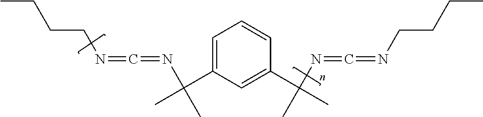 | 245550-09-8 |
| 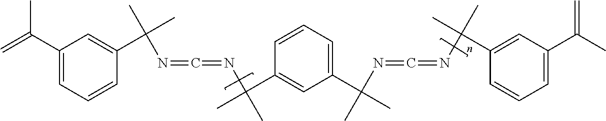 | 191538-50-8 |
| 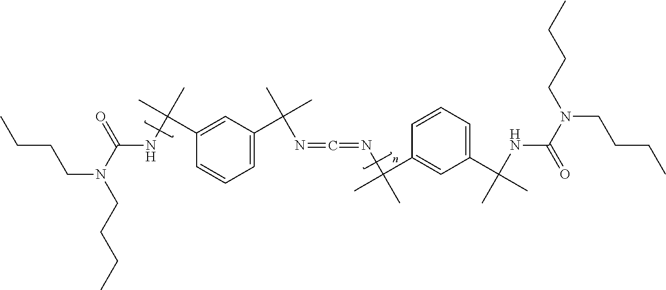 | 175075-22-6 |
| 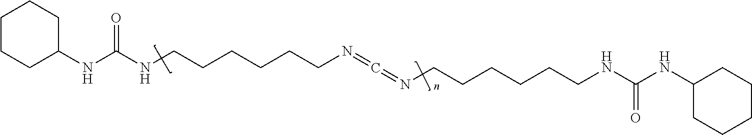 | 2657630-61-8 |
| 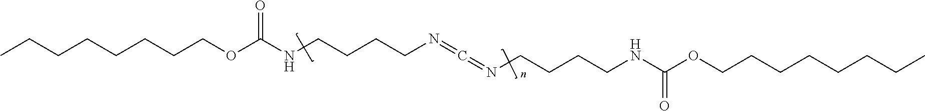 | 2762461-30-1 |
| 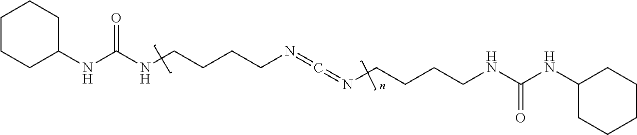 | 2762461-29-8 |

Suitable polycarbodiimides having different end capping R-groups are listed in Table 2.

TABLE 2

| Structure | CAS-registry nr. |
|---|---|
| 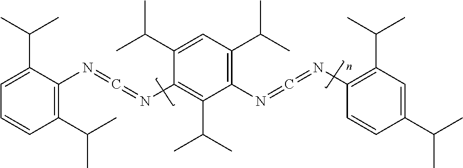 | 1703775-47-6 |
| 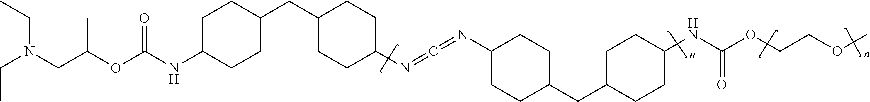 | 2762319-28-6 |
| 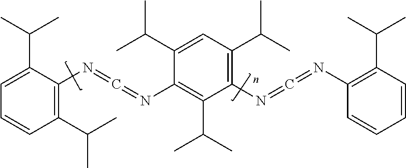 | 1703775-48-7 |

Suitable examples of carbodiimides are listed in Table 3:

TABLE 3

| Structure | CAS-registry nr. |
|---|---|
| 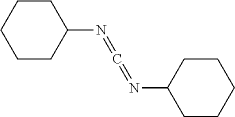 [SMILES: C(=NC1CCCCC1)=NC1CCCCC1] | 538-75-0 |
| 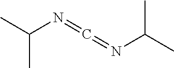 | 693-13-0 |
| 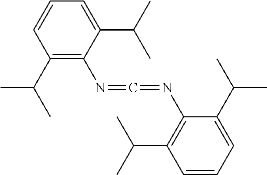 [SMILES: CC(C)c1cccc(C(C)C)c1N=C=Nc1c(C(C)C)cccc1C(C)C] | 2162-74-5 |
| 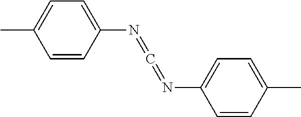 | 726-42-1 |
| 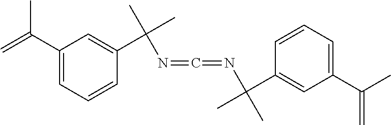 [SMILES: C=C(C)c1cccc(C(C)(C)N=C=NC(C)(C)c2cccc(C(=C)C)c2)c1] | 190319-90-5 |

### Dispersant

The dispersant present in the reaction liquid according to the invention is a compound capable of dispersing the polycarbodiimide according to Formula I, II, III or IV or the carbodiimide according to Formula V or VI. Preferably, the dispersant is a polymeric dispersant, more preferably a non-ionic polymeric dispersant. A suitable non-ionic polymeric dispersant is a water-soluble copolymer selected from the group consisting of a PPO/PEO copolymer, an arylethylphenyl polyglycol ether, a polycarbodiimid having a structure wherein the isocyanate groups at the endgroups are end-capped by means of a hydrophilic group such as an alkylene oxide group and fatty acid derivatives with EO/PO moieties.

Suitable linear PPO-PEO copolymers preferably have polymeric or oligomeric hydrophobic segments. They are also referred as segmented copolymers. Typical examples are diblock or triblock copolymers based on EO and PO. Typical trade names are Pluronic RPE grades or Pluronic PE grades, available from BASF and Synperonic grades from Croda. In case of triblock copolymers, the outer blocks have a different polarity than the mid-block. The most polar blocks can be located at the outside but can also be located in the middle as the mid-block. Besides diblock and triblock copolymers also multiblock copolymers can be used.

The hydrophilicity of the hydrophilic segment can be changed by variation of the number of EO units but instead of EO also other hydrophilic alkylene oxide units can be used such as based on glycidol, other oxiranes, glycerol, glucitol, glucoside, etc. Typical trade names are Lutensol (BASF), Plurafac (BASF), Tergitol (Dow), Etocas (Croda), Pionin (NOF), Emulsogen (Clariant), Silco sperse (Keim Additec).

Other specific examples of the water soluble polymers useful in the reaction liquid of the invention are arylethylphenyl polyglycol ethers such as Lucramul DA554 from LEVACO Chemicals GmbH.

Particularly preferred the water-soluble linear copolymers based on EO and PO have an average molecular weight between 3000 g/mol and 30000 g/mol, more preferably between 4000 g/mol and 15000 g/mol and having a PPO/PEO weight ratio between 0.1 and 2.5. The average Mw (average molar mass) is determined from the OH number (mg KOH/g) obtained by titration e.g., using method ISO 4326.

The water-soluble polymer in the reaction liquid of the invention is preferably non-ionic. Due to its non-ionic character, the water-soluble polymer interacts less with the cationic fixing agent in the pre-treatment liquid during the drying step of the reaction liquid. Higher gloss values are then obtained.

The water-soluble polymer is present in the reaction liquid composition in an amount ranging from 1 wt. % to 40 wt. %, based on the total dry solids content of the treatment composition, more preferably in an amount ranging from 2 wt. % to 35 wt. %, based on the total dry solids content of the treatment composition, most preferably in an amount ranging from 5 wt. % to 20 wt. % based on the total dry solids content of the treatment composition.

### Water-Soluble Organic Solvents

One or more water-soluble organic solvents may be present in the reaction liquid from the ink set according to the invention for a variety of reasons. For example, it can be advantageous to add a small amount of an organic solvent to prevent fast drying of the reaction liquid at the nozzle of the inkjet head.

Preferable water-soluble organic solvents are polyols (e.g., ethylene glycol, glycerin, 2-ethyl-2-(hydroxymethyl)-1,3-propanediol, tetraethylene glycol, triethylene glycol, tripropylene glycol, 1,2,4-butanetriol, diethylene glycol, propylene glycol, dipropylene glycol, butyleneglycol, 1,6-hexanediol, 1,2-hexanediol, 1,5-pentanediol, 1,2-pentanediol, 2,2-dimethyl-1,3-prapanediol, 2-methyl-2,4-pentanediol, 3-methyl-1,5-pentanediol, 3-methyl-1,3-butanediol, and 2-methyl-1,3-propanediol), N-hydroxyethyl-pyrrolidon, N-butyl-pyrrolidon, amines (e.g., ethanolamine, and 2-(dimethylamino) ethanol), monohydric alcohols (e.g., methanol, ethanol, and butanol). Other useful examples which are listed in the Swiss list A and hence compatible with food packaging are: alkyl ethers of polyhydric alcohols (e.g., diethylene glycol monomethyl ether, diethylene glycol monobutyl ether, triethylene glycol monomethyl ether, triethylene glycol monobutyl ether, ethylene glycol monomethyl ether, ethylene glycol monobutyl ether, propylene glycol monomethyl ether, propylene glycol monobutyl ether, and dipropylene glycol monomethyl ether), 2,2′-thiodiethanol, amides such as N,N-dimethylformamide, heterocycles such as 2-pyrrolidone and N-methyl-2-pyrrolidone, and acetonitrile. These solvents may be used alone or in combination of two or more.

The organic solvent is preferably added to the reaction liquid formulation in an amount of 0.1 to 45 wt. % based on the total weight of the liquid.

### Wax

The reaction liquid as comprised in the ink set according to the invention may comprise a wax. The wax may improve the durability of the printed image. Generally, any suitable wax may be used in the reaction liquid composition. As such, the wax may be polyethylene waxes, petroleum waxes, paraffin waxes, carnauba waxes, polypropylene waxes, crystalline and microcrystalline waxes, amide waxes (oleamide, stearamide, erucamide, cyclic amide, etc. . . . ), and combinations thereof. In an aspect of the invention, the wax may be a high density polyethylene wax.

In an aspect of the invention, the wax may be a polyethylene wax or modified paraffin wax. An example of polyethylene wax includes high density polyethylene (HDPE) wax, which has a density ranging from about 0.93 g/mL to 0.97 g/mL. The density of HDPE is generally higher than the density of low density polyethylene (LDPE) due, at least in part, to a smaller amount of molecular branching in HDPE.

An example of modified paraffin wax particles includes paraffin wax that has been modified to improve dispersability in water, e.g., via emulsification. The modified paraffin wax may be surface modified, chemically modified, etc.

Some specific examples of wax that may be used include those of the JONCRYL Wax series (such as JONCRYL Wax 22, JONCRYL Wax 26, and JONCRYL Wax 120 available from BASF Corp.), those of the AQUACER series (such as AQUACER 498, AQUACER 501, AQUACER 505, AQUACER 513, AQUACER 530, AQUACER 531, AQUACER 535, AQUACER 537, AQUACER 539, and AQUACER 552 available from BYK-Gardner, Columbia, Md.) and Liquilube 404E from Lubrizol.

The wax may have i) a high melting temperature T and/or ii) a small average particle size. In an example, the wax may have a high melting T such as one that is equal to or greater than 90° C. Further, the wax may have an average particle size (in terms of effective diameter assuming that the individual wax particles are not perfectly spherical) ranging from 0.03 μm to 1.5 μm, more preferably from 0.05 μm to 1 μm (D50). If the particle size exceeds these upper limits, jetting reliability problems of the varnish are likely to occur.

The wax may be present in the reaction liquid in an amount ranging from 0.1 to 10 wt. %, more preferably from 0.3 to 5 wt. %, relative to the total weight of the reaction liquid.

### Resin Particles

Examples of the resin particles included in the reaction liquid include well-known resins such as a urethane-based resin, an acrylic resin, a fluorene-based resin, a polyolefin-based resin, a rosin modified resin, a terpene-based resin, a poly-ester-based resin, a polyamide-based resin, an epoxy-based resin, and a vinyl chloride-based resin. The vinyl chloride-based resin includes a vinyl chloride copolymer such as a vinyl chloride-vinyl acetate copolymer. These resins may be used alone, or two or more thereof may be used in combination.

Among the aforementioned resin particles, the resin included in the reaction liquid is preferably a urethane-based resin, an acrylic resin, or a styrene-acrylic resin.

As the urethane-based resin, commercially available products may be used, for example, commercially available products such as SUPER FLEX 460, 460s, 840, E-4000 (trade name, manufactured by DKS Co., Ltd.), RESAMINE D-1060, D-2020, D-4080, D-4200, D-6300, D-6455 (trade name, manufactured by Dainichiseika Color & Chemicals Mfg. Co., Ltd.), TAKELAC WS-6021, W-512-A-6 (trade name, manufactured by Mitsui Chemicals Polyurethanes INC.,), SUNCURE 2710 (trade name, manufactured by LUBRIZOL Corporation), and PermalinUA-150 (trade name, manufactured by Sanyo Chemical Industries, Ltd.) may be used.

The acrylic resin is a general name of a polymer obtained by polymerizing at least an acrylic monomer such as (meth)acrylic acid and (meth)acrylate, and the examples thereof include a (meth)acryl resin obtained from the acrylic monomer, and a copolymer of the acrylic monomer and monomers other than the acrylic monomer (for example, a vinyl based monomer such as styrene). Acrylamide and acrylonitrile can be also used as the acrylic monomer. The acrylic resin can be non-reactive or self-cross linking. As a resin emulsion using the acrylic resin as a raw material, commercially available products may be used, and the examples thereof include FK-854 (trade name, manufactured by CHIRIKA. Co., ltd.), Mowinyl 952B, 718A (trade name, manufactured by The Nippon Synthetic Chemical Industry Co., Ltd.), Nipol LX852, and LX874 (trade name, manufactured by ZEON Corporation).

Examples of styrene-acrylic resins include poly(styrene-alkyl acrylate), polystyrene-1,3-diene), poly(styrene-alkyl methacrylate), poly(styrene-alkyl acrylate-acrylic acid), poly(styrene-1,3-diene-acrylic acid), poly(styrene-alkyl methacrylate-acrylic acid), poly(styrene-alkylacrylate-acrylonitrile-acrylic acid), and poly(styrene-1,3-diene-acrylonitrile-acrylic acid). Other examples include poly(styrene-propyl acrylate), poly(styrene-butylacrylate), poly(styrene-butadiene-acrylic acid), poly(styrene-butadiene-methacrylic acid), poly(styrene-butadieneacrylonitrile-acrylic acid), poly(styrene-butyl acrylateacrylic acid), poly(styrene-butyl acrylate-methacrylic acid), poly(styrene-butyl acrylate-acrylononitrile), poly(styrenebutyl acrylate-acrylononitrile-acrylic acid). Commercial styrene-acrylic resins are Neocryl D2101 (Covestro) and Bonron PS001 and Bonron PS002 (Mitsui).

The polyolefin-based resin has olefin such as ethylene, propylene, and butylene as a structural skeleton, and the well-known resins may be appropriately selected to be used. As the olefin resin, commercially available products may be used, and the examples thereof include Arrowbase CB-1200 and CD-1200 (trade name, manufactured by UNITIKA LTD.).

The reaction liquid preferably contains the resin in an amount from 1 wt. % to 30 wt. % with respect to the total mass of the reaction liquid. When the content of the resin in the reaction liquid is within the aforementioned range, the effect of improving rub resistance of the image tends to become more excellent. If the amount is above the aforementioned range, jettability problems of the reaction liquid by means of inkjet heads may occur.

### Polyether Siloxane Surfactant

The reaction liquid according to the invention may contain a polyether siloxane surfactant. A preferable surfactant it is according to formula V:

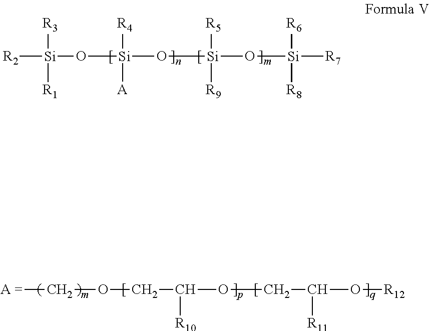

In formula V, R1 to R9 independently represent an alkyl group with 1 to 6 atoms, preferably a methyl group, or an aryl group, preferably a phenyl group. n and m independently represent an integer of 0 or more, but preferably 0 to 8. R10 to R11 independently represent a hydrogen atom or an alkyl group, preferably a methyl group. p and n preferably represent an integer of 0 or more.

In case m=0 and n=1, one defines the structure as a trisiloxane. In case n and m are larger than 0, one defines the structure as a graft copolymer. The polyether units having a degree of polymerization p and the polyether units having a degree of polymerization of q. These units could be block-wise arranged or randomly arranged. In case R10=R11, then the graft contains only one type of alkylene oxide unit. Preferably the graft A contains one or two different types of alkylene oxide units. In case the graft A contains one type of alkylene oxide, preferred is ethylene oxide. In case two types of alkylene oxides are present the then preferably ethylene oxide and propylene oxide are used. m in spacer=preferably 2 or 3, respectively prepared from vinyl or allyl terminated poly ethers.

The preferable content of the polyether siloxane-based surfactant is equal to 0.03 wt. % or more, more preferable equal to 0.2 wt. % or more based on the total weight of the liquid. If the content is lower, water resistance or wet rub resistance of the printed image is insufficient.

Besides the compounds of Formula V having trialkyl silyl end groups, one can also have a similar structure having alkyl end groups, substituted alkyl groups, aryl or substituted alkyl groups.

Typical examples of trisiloxane structures are Byk 3450, Byk 3451, Tego wet 260, Tego wet 240, Tego wet KL245, Korasilon additive PS1, Korasilon additive PS2

Typical examples of graft copolymer structures are Tego glide 410, Korasilon addtive PS5 and Coatosil 7607.

Another silicone polyether structure which can be used is shown in Formula VI, ie. a silicone polyether block copolymer.

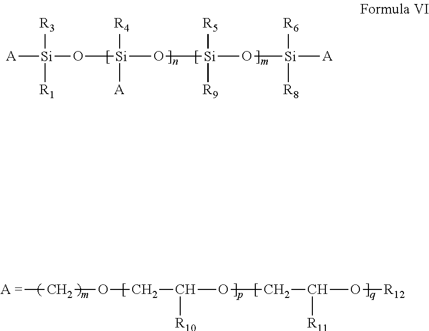

In formula VI, R1 to R9 independently represent an alkyl group with 1 to 6 atoms, preferably a methyl group, or an aryl group, preferably a phenyl group. n and m independently represent an integer of 0 or more, but preferably 0 to 8. R10 to R11 independently represent a hydrogen atom or an alkyl group, preferably a methyl group. p and n preferably represent an integer of 0 or more.

In a typical triblock copolymer, n=0, representing a siloxane-polyether-siloxane triblock copolymer. An example of a block copolymer silicone surfactant is Byk 3420, having an ABA structure (A=polyether, B=silicone).

Furthermore, the polyether siloxane surfactant can be a structure where both the polyether and siloxane segments are present as graft. Examples of polyether siloxanes which have siloxane grafts are Byk 3565, Byk 3566 and Byk 3568

The polyether siloxane structures can also be designed to be better hydrolytically stable, such as tradenames Silwet HS312 and Silwet HS212, available from Momentive.

Suitable surfactants which are commercially available are Olfine PD-501 (Nissin Chemical Industry Co., Ltd.) Olfine PD-570 (Nissin Chemical Industry Co., Ltd.), BYK-333 (BYK Co., Ltd.), BYK-347 (BYK Co., Ltd.), BYK-348 (BYK Co., Ltd.).

The presence of the polyether siloxane surfactant in the reaction liquid of the invention is increasing the rub resistance in dry and wet conditions (water resistance). Without being bound by a theory, it is thought that the polyether siloxane reduces the friction coefficient of reaction liquid coating after drying, lowering the impact of mechanical damage of the image due to rubbing.

### Layer Thickness

The coverage of the reaction liquid coating after drying is preferably from 0.2 g/m² to 2.5 g/m², more preferably from 0.6 to 2.0 g/m². If the coverage is less than 0.2 g/m² the resistance against dry and wet rubbing is insufficient. If the coverage is above 2.5 g/m² drying of the applied reaction liquid is slow which limits the printing speed.

### A.2. Aqueous Pre-Treatment Liquid

The ink set according to the invention may comprise an aqueous treatment liquid to be adhered on the substrate before or during inkjet printing the image. The aqueous pre-treatment liquid comprises water as a vehicle and a fixing agent. The aqueous vehicle may include one or more water-soluble organic solvents.

### Fixing Agent

The fixing agent present in the pre-treatment liquid is preferably a multivalent metal salt; a cationic polymer or an organic acid. The fixing agent serves to crash, precipitate or destabilize the ink colorants and hence fix them to the substrate. This leads to an improved image quality (less bleeding, less coalescence).

The polyvalent metal salt may be present in the pre-treatment liquid to improve inkjet print quality. Generally, the polyvalent metal salt may be any water-soluble polyvalent metal salt. In specific examples, the polyvalent metal salt may include calcium chloride (CaCl₂)), magnesium chloride (MgCl₂), magnesium sulfate (MgSO₄), aluminium chloride (AlCl₃), calcium nitrate (Ca(NO₃)₂), magnesium nitrate (Mg(NO₃)₂), magnesium acetate (Mg(CH₃COO)₂), zinc acetate (Zn(CH₃COO)₂) calcium propionate (Ca(C₂H₅COO)₂), or a combination thereof. In a particular example, the polyvalent metal salt may be calcium chloride. In further examples, the polyvalent metal salt may include a metal cation selected from calcium, copper, nickel, magnesium, zinc, barium, iron, aluminium, chromium, or another polyvalent metal.

The polyvalent metal salt may also include an anion. In some examples, the anion may be fluoride, chloride, iodide, bromide, nitrate, chlorate, sulfate, acetate, or RCOO where R is hydrogen or any low molecular weight hydrocarbon chain, e.g., C1 to C12. In a more specific example, the anion may be a carboxylate derived from a saturated aliphatic monocarboxylic acid having 1 to 6 carbon atoms or a carbocyclic monocarboxylic acid having 7 to 11 carbon atoms. Examples of saturated aliphatic monocarboxylic acid having 1 to 6 carbon atoms may include formic acid, acetic acid, propionic acid, butyric acid, isobutyric acid, valeric acid, isovaleric acid, pivalic acid, and/or hexanoic acid. The cationic salt may also be a mixture of two or more different cationic salts

In some cases, the polyvalent metal salt may be present in an amount from 1 wt. % to 99 wt. % with respect to the entire weight of the pre-treatment liquid. In more specific examples, the polyvalent metal salt may be present in an amount from 5 wt. % to 65 wt. %, more preferably from 25 wt. % to 60 wt. %, with respect to solids content of the pre-treatment liquid. If the amounts are below the lower limits, insufficient fixing of the colorants occur resulting in a reduced image quality.

Polymeric cationic polymers, suitable as fixing agent in the pre-treatment liquid contain either guanidinium or fully quaternized ammonium functionalities, such as quaternized polyamine copolymers. Generally, the weight average molecular weight (Mw) of the cationic polymer allows viscosity less than 25 cP at 25° C., as measured on a Brookfield viscometer. Typical Mw are less than 500.000, and in one aspect, less than 50.000.

Suitable classes of cationic polymers that can be used include, but are not limited to, quaternized polyamines, dicyandiamide polycations, diallyldimethyl ammonium chloride copolymers, quaternized dimethylaminoethyl (meth)acrylate polymers, quaternized vinylimidizol polymers, alkyl guanidine polymers, alkoxylated polyethylene imines, and mixtures thereof.

### Surfactant

The pre-treatment liquid may contain a surfactant. Any known surfactant may be used but preferably a glycol surfactant and/or an acetylene alcohol surfactant and/or a polysiloxane surfactant is used. The use of the acetylene glycol surfactant and/or the acetylene alcohol surfactant and/or the polysiloxane surfactant improves the drying property in printing to allow high-speed printing.

The acetylene glycol surfactant and/or the acetylene alcohol surfactant is preferably one or more selected from 2, 4, 7, 9-tetramethyl-5-decine-4, 7-diol, alkylene oxide adducts of 2,4,7,9-tetramethyl-5-decine-4, 7-diol, 2,4-dimethyl-5-decin-4-ol, and alkylene oxide adducts of 2,4-dimethyl-5-decin-4-ol. These are available from Nissin Chemical Industry, for example, as Olfine (registered trademark) E series, such as Olfine E1010, or from Evonik (formerly Air Products (GB)) as Surfynol (registered trademark), 104, Surfynol 465 and Surfynol 61.

### Resin

The pre-treatment liquid may contain resin particles. The resin particles are preferably selected from the group consisting of poly(urethanes), poly(acrylates) or waxes. Suitable examples of resin particles are found in § A.1.

In one preferred embodiment of the invention, the pre-treatment liquid may contain a water-soluble copolymer selected from the group consisting of a PPO/PEO copolymer, an arylethylphenyl polyglycolether and fatty acid derivatives with EO/PO moieties. Suitable examples can be found in § A. 1.

### Additives

The pre-treatment liquid may further contain a biocide, a wax, a thickener, a pH adjuster and a corrosion inhibitor

The pre-treatment liquid may comprise a thickener to increase the viscosity in the desired range of the application method.

The thickener is added preferably in an amount of 0.01 to 20 wt. %, more preferably 0.1 to 10 wt. % based on the liquid.

A biocide may be added to the pre-coat liquid to prevent unwanted microbial growth, which may occur over time. The biocide may be used either singly or in combination. Suitable biocides for the ink-jet ink of the present invention include sodium dehydroacetate, 2-phenoxyethanol, sodium benzoate, sodium pyridinethion-1-oxide, ethyl p-hydroxybenzoate and 1,2-benzisothiazolin-3-one and salts thereof.

Preferred biocides are Proxel™ GXL and Proxel™ Ultra 5 available from ARCH UK BIOCIDES and Bronidox™ available from COGNIS.

A biocide is preferably added to the aqueous medium in an amount of 0.001 to 3 wt. %, more preferably 0.01 to 1.0 wt. %, each based on the total weight of the liquid.

The pre-treatment liquid may contain at least one pH adjuster. Suitable pH adjusters include organic amines such as triethanolamine, NaOH, KOH, NEt₃, NH₃, HCl, HNO₃, Na-acetate and H₂SO₄. In a preferred embodiment, the pre-coat liquid has a pH equal to or lower than 9.

### A.3. Aqueous Inkjet Ink

The aqueous inkjet ink as part of the ink set according to the invention, which is used to print at least upon the areas where the pre-treatment liquid has been applied to obtain a printed image, comprises colorants such as dyes and pigments. The pigments are preferably stabilized by anionic dispersing groups. The pigments can also be additionally stabilised by polymeric dispersants, surfactants or a combination thereof to achieve extra colloidal stability.

The aqueous medium of the ink contains water but may include one or more water-soluble organic solvents. Suitable water-soluble organic solvents are described in § A.1.

In a preferred embodiment of the invention, the aqueous inkjet ink comprises a resin and/or a wax. Suitable waxes are described in § A.1.

The aqueous inkjet ink may further comprise a surfactant, a humectant, a biocide, a resin and a thickener as an additive.

### A.3.1. Pigment

The pigments in the aqueous inkjet ink according to the invention may be black, white, cyan, magenta, yellow, red, orange, violet, blue, green, brown, mixtures thereof, and the like. A colour pigment may be chosen from those disclosed by HERBST, Willy, et al. Industrial Organic Pigments, Production, Properties, Applications. 3rd edition. Wiley—VCH, 2004. ISBN 3527305769.

Suitable pigments are disclosed in paragraphs [0129] to [0138] of WO 2008/074548.

The pigment particles are dispersed in an aqueous medium using a polymeric dispersant, a surfactant or a combination thereof. Self-dispersible pigments can also be used. The latter prevents interaction of the polymeric dispersant with the dispersing groups of binders or capsules which may be included in the inkjet ink (see below).

A self-dispersible pigment is a pigment having on its surface covalently bonded anionic hydrophilic groups or salt-forming groups, that allow the pigment to be dispersed in an aqueous medium without using a surfactant or a resin.

The technology for making self-dispersible pigments is well-known. For example, EP1220879A discloses pigments having attached a) at least one steric group and b) at least one organic ionic group and at least one amphiphilic counterion, wherein the amphiphilic counterion has a charge opposite to that of the organic ionic group that are suitable for inkjet inks. Also, EP906371A discloses suitable surface-modified coloured pigment having attached hydrophilic organic groups containing one or more ionic groups or ionizable groups. Suitable commercially available self-dispersible colour pigments are, for example, the CAB-O-JET™ inkjet colorants from CABOT.

Pigment particles in inkjet inks should be sufficiently small to permit free flow of the ink through the inkjet-printing device, especially at the ejecting nozzles. It is also desirable to use small particles for maximum colour strength and to slow down sedimentation.

The average pigment particle size is preferably between 0.050 and 1 μm, more preferably between 0.070 and 0.300 μm and particularly preferably between 0.080 and 0.200 μm. Most preferably, the numeric average pigment particle size is no larger than 0.150 μm. The average particle size of pigment particles is determined with a Brookhaven Instruments Particle Sizer BI90plus based upon the principle of dynamic light scattering.

Suitable white pigments are given by Table 2 in of WO 2008/074548. The white pigment is preferably a pigment with a refractive index greater than 1.60. The white pigments may be employed singly or in combination. Preferably titanium dioxide is used as pigment with a refractive index greater than 1.60. Suitable titanium dioxide pigments are those disclosed in and in of WO 2008/074548.

Also, special colorants may be used, such as fluorescent pigments for special effects in clothing, and metallic pigments for printing a luxury look of silver and gold colours on textiles.

Suitable polymeric dispersants are copolymers of two monomers but they may contain three, four, five or even more monomers. The properties of polymeric dispersants depend on both the nature of the monomers and their distribution in the polymer. Co-polymeric dispersants preferably have the following polymer compositions:
statistically polymerized monomers (e.g. monomers A and B polymerized into ABBAABAB);
alternating polymerized monomers (e.g. monomers A and B polymerized into ABABABAB);
gradient (tapered) polymerized monomers (e.g. monomers A and B polymerized into AAABAABBABBB);
block copolymers (e.g. monomers A and B polymerized into AAAAABBBBBB) wherein the block length of each of the blocks (2, 3, 4, 5 or even more) is important for the dispersion capability of the polymeric dispersant;
graft copolymers (graft copolymers consist of a polymeric backbone with polymeric side chains attached to the backbone); and
mixed forms of these polymers, e.g. blocky gradient copolymers.

Suitable dispersants are DISPERBYK™ dispersants available from BYK CHEMIE, JONCRYL™ dispersants available from JOHNSON POLYMERS and SOLSPERSE™ dispersants available from ZENECA. A detailed list of non-polymeric as well as some polymeric dispersants is disclosed by MC CUTCHEON. Functional Materials, North American Edition. Glen Rock, N.J.: Manufacturing Confectioner Publishing Co., 1990. p. 110-129.

The polymeric dispersant has preferably a number average molecular weight Mn between 500 and 30000, more preferably between 1500 and 10000.

The polymeric dispersant has preferably a weight average molecular weight Mw smaller than 100,000, more preferably smaller than 50,000 and most preferably smaller than 30,000.

The pigments are preferably present in the range of 0.01 to 15%, more preferably in the range of 0.05 to 10% by weight and most preferably in the range of 0.1 to 5% by weight, each based on the total weight of the inkjet ink. For white inkjet inks, the white pigment is preferably present in an amount of 3% to 40% by weight of the inkjet ink, and more preferably 5% to 35%. An amount of less than 3% by weight cannot achieve sufficient covering power.

In a preferred embodiment of the invention the aqueous ink comprises a pigment which is encapsulated by means of a cross-linked polymeric shell. Encapsulated pigments provide printed images having improved physical properties such as water resistance and dry rub resistance with respect to pigments dispersed by means of un-cross-linked polymers.

Suitable encapsulated pigments are provided by Lubrizol as Diamond HSDX-dispersions and by Fujifilm as RxD pigment dispersions such as APD1000 and APD400 premium dispersions.

### A.3.2. Vehicle

The aqueous ink according to the invention comprises water as a vehicle. The aqueous vehicle may further include one or more water-soluble organic solvents.

The one or more organic solvents may be added for a variety of reasons. For example, it can be advantageous to add a small amount of an organic solvent to improve the dissolution of a compound in the ink composition to be prepared or to prevent fast drying of the ink at the nozzle of the inkjet head. Preferable water-soluble organic solvents are listed in § A.1.

Preferably, if two or more organic solvents are present in the ink, one of the organic solvents being in the highest amount, has a boiling point of 150° C. or more and 250° C. or less. If the boiling point is below this range, the solvent is very volatile and may give an unwanted odor to the ink. When the boiling point of the solvent is above the mentioned range, the solvents have the tendency of not being eliminated in the drying step and remain in the printed image leading to a reduced resistance to rubbing and scratching of the printed image. This water-soluble organic solvent is preferably added to the ink composition formulation in an amount of 0.1 to 55 wt. % based on the total weight of the ink.

### A.3.3. Resin

The ink jet ink composition according to the invention may comprise a resin. The resin is often added to the ink jet ink formulation to achieve a good adhesion of the pigment to the recording medium. The resin is preferably a polymer and suitable resins can be an acrylic based resin, a urethane resin or a wax. The wax in the inkjet ink of the ink set according to the invention increases the dry and wet abrasion resistance of the printed image.

The polyurethane resin is to be incorporated in the ink formulation as a dispersion and may be selected from the group consisting of aliphatic polyurethane dispersions, aromatic polyurethane dispersions, anionic polyurethane dispersions, non-ionic polyurethane dispersions, aliphatic polyester polyurethane dispersions, aliphatic polycarbonate polyurethane dispersions, aliphatic acrylic modified polyurethane dispersions, aromatic polyester polyurethane dispersions, aromatic polycarbonate polyurethane dispersions, aromatic acrylic modified polyurethane dispersions, for example, or a combination of two or more of the above.

A preferred urethane resin to be used as dispersion in the ink of the invention is a polyester resin including a structural unit containing a urethane bond. Among such resins, a water-soluble or water-dispersible urethane-modified polyester resin is preferred. It is preferable that the urethane-modified polyester resin include at least one structural unit derived from a hydroxyl group-containing polyester resin (polyester polyol) and at least one structural unit derived from an organic polyisocyanate.

Furthermore, the hydroxyl group-containing polyester resin is a resin formed by an esterification reaction or transesterification reaction between at least one polybasic acid component and at least one polyhydric alcohol component.

A preferred polyurethane resin to be included in the ink of the invention is a polyurethane resin obtainable by reacting a polyester polyol, a polyether diol, a polyol containing an anionic group and a polyisocyanate. A particular preferred polyurethane resin is a polyurethane resin obtainable by reacting a polyester polyol, a polyether diol, a polyol containing an anionic group and a polyisocyanate, and wherein the polyester polyol is obtained by reacting an aromatic polycarboxylic acid and a polyol. Examples of suitable polyurethane resins and their preparations are disclosed in the unpublished patent application EP16196224.6.

Some examples of suitable polyurethane dispersions are NEOREZ R-989, NEOREZ R-2005, and NEOREZ R-4000 (DSM NeoResins); BAYHYDROL UH 2606, BAYHYDROL UH XP 2719, BAYHYDROL UH XP 2648, and BAYHYDROL UA XP 2631 (Bayer Material Science); DAOTAN VTW 1262/35WA, DAOTAN VTW 1265/36WA, DAOTAN VTW 1267/36WA, DAOTAN VTW 6421/42WA, DAOTAN VTW 6462/36WA (Cytec Engineered Materials Inc., Anaheim CA); and SANCURE 2715, SANCURE 20041, SANCURE 2725 (Lubrizol Corporation), for example, or a combination of two or more of the above.

Acrylic based resins include polymers of acrylic monomers, polymers of methacrylic monomers, and copolymers of the aforementioned monomers with other monomers. These resins are present as a suspension of particles having an average diameter of about 30 nm to about 300 nm. The acrylic latex polymer is formed from acrylic monomers or methacrylic monomer residues. Examples of monomers of the acrylic latex polymer include, by way of illustration, acrylic monomers, such as, for example, acrylate esters, acrylamides, and acrylic acids, and methacrylic monomers, such as, for example, methacrylate esters, methacrylamides, and methacrylic acids. The acrylic latex polymer may be a homopolymer or copolymer of an acrylic monomer and another monomer such as, for example, a vinyl aromatic monomer including, but not limited to, styrene, styrene butadiene, p-chloromethylstyrene, divinyl benzene, vinyl naphthalene and divinylnaphthalene.

Some examples of suitable acrylic latex polymer suspensions are, JONCRYL 537 and JONCRYL 538 (BASF Corporation, Port ArthurTX); CARBOSET GA-2111, CARBOSET CR-728, CARBOSET CR-785, CARBOSET CR-761, CARBOSET CR-763, CARBOSET CR-765, CARBOSET CR-715, and CARBOSET GA-4028 (Lubrizol Corporation); NEOCRYL A-1110, NEOCRYL A-1131, NEOCRYL A-2091, NEOCRYL A-1127, NEOCRYL XK-96, and NEOCRYL XK-14 (DSM); and BAYHYDROL AH XP 2754, BAYHYDROL AH XP 2741, BAYHYDROL A 2427, and BAYHYDROL A2651 (Bayer), for example, or a combination of two or more of the above.

The ink jet ink composition according to the invention may comprise a capsule. Capsules, more preferably, nanocapsules are often incorporated in ink jet ink formulations to encapsulate colouring agents (US2009227711A, JP2004075759) or to encapsulate reactive ingredients which can cross-link. Particularly useful are the nanocapsules disclosed in WO2015158649 [0037-0110]: The nanocapsules have a polymeric shell surrounding a core containing reactive chemistry. The shell material includes polyureas, polyurethanes, polyesters, polycarbonates, polyamides, melamine based polymers and mixtures thereof, with polyureas and polyurethanes being especially preferred. Other particularly useful nanocapsules are disclosed in WO2016165970 [0051-0138]: the nanocapsules are selfdispersable and include a dispersing group covalently coupled to the shell polymers. The core of the nanocapsules in WO2015158649 [0037-0110] and WO2016165970 [0051-0138] comprise reactive chemistry which is able to form a reaction product upon application of heat and/or light, allowing a wide variety of substrates to be addressed. Other suitable reactive chemistry is the one which is activated upon radiation as described in WO2015158649 [0068-0110].

The resins are preferably present in the inkjet ink in an amount of no more than 30 wt. %, preferably between 5 and 25 wt. % based on the total weight of the ink.

### A.3.4. Additives

The ink composition may contain a surfactant. Any known surfactant may be used but preferably a glycol surfactant and/or an acetylene alcohol surfactant and/or a polysiloxane surfactant is to be used. Suitable surfactants can be found in § A.2.

A biocide may be added to the ink to prevent unwanted microbial growth, which may occur over time. Suitable biocides are listed in § A.2.

A biocide is preferably added to the aqueous medium in an amount of 0.001 to 3 wt. %, more preferably 0.01 to 1.0 wt. %, each based on the total weight of the ink.

The ink may further comprise an antifoaming agent, an anti-corrosion additive, humectants leading to a surface tension reduction such as 1,2 hexanediol, n-butanol, n-pentanol.

### B. Recording Method

### B.1. Application Method of the Pre-Treatment Liquid

The ink set according to the invention may comprise a pre-treatment liquid. The pre-treatment liquid is applied to treat the substrate preferably before jetting the inkjet ink. The pre-treatment liquid serves to crash, precipitate or destabilize the ink colorants and hence fix them to the substrate. This leads to an improved image quality (less bleeding, less coalescence). The pre-treatment liquid as part of the ink set according to the invention is suitable to be applied onto different substrates, absorbing and non-absorbing ones. A substrate is characterized as absorbing, when the amount of absorbed water after a contact time of 60s is at least 10 g/m². Absorbing substrates include paper, card board, white lined chipboard, corrugated board, packaging board, folding board, wood, ceramics, stone, leather and textile. Non-absorbing substrates include metal, glass, polypropylene, polyvinylchloride, PET, PMMA, polycarbonate, polyamide, polystyrene or co-polymers thereof.

The pre-treatment liquid is particularly suited for being coated or jetted onto papers intended for packaging applications, more preferably packaging applications including absorbing substrate such as card board, paper lines, corrugated board, packaging board, folding board and paper. The paper can be a single layer of a multilayer paper.

The paper may be brown Kraft, White Top or bleached board. The paper may be manufactured from chemical, wood, or recycled fibre. As an example, the paper may be a liner intended for printing on page wide web presses and converted into corrugated boxes. In this aspect, the liner paper may be used as a double face liner and may be converted directly in a corrugator or laminated onto a double face liner after corrugation. The paper may also be boards used for boxes and other packaging applications.

All well-known conventional methods can be used for coating or impregnating the pre-treatment liquid on a substrate. Examples of the method include air knife coating, blade coating, roll coating, gravure coating and spraying. More preferably the pre-treatment liquid is applied by means of a jetting technique.

The pre-treatment liquid is then applied using an ink jet head or valve jet head. This means of applying the pre-treatment composition, which is preferably according to an image, has the advantage that the amount of required pre-treatment liquid is substantially lower than with the other application methods. By means of a jetting head, it is possible to apply the pre-treatment liquid onto areas of the substrate where the image should be printed. Suitable ink jet head types for applying the pre-treatment liquid are piezoelectric type, continuous type, thermal print head type, Memjet-type or valve jet type or through-flow heads as described in § B.2.

After applying the pre-treatment liquid onto a substrate, the coating is preferably at least partially dried before printing the image onto the treated substrate such as to form a pre-coat layer.

Substrates to which the pre-treatment composition has been applied may be dried and optionally undergo a heat treatment, before the subsequent ink jetting step with the colorant containing ink onto the formed pre-coat layer. Examples of the heating process include, but are not limited to, heat press, atmospheric steaming, high-pressure steaming, and THERMOFIX. Any heat source can be used for the heating process; for example, an infrared ray lamp is employed.

In another embodiment of the invention, the pre-treatment composition, is not substantially dried before the image is printed by means of the jetting of the aqueous ink jetting step.

### B.2. Ink Jetting & Drying

The aqueous inkjet ink as part of the ink set according to the invention is applied to the substrate. If a pre-treatment liquid is applied to the substrate, the inkjet ink is preferably applied onto the parts where the pre-treatment liquid has been applied on or where a pre-coat layer has been formed. The aqueous inkjet ink comprises a colorant, more preferably a pigment. A preferred method of applying the aqueous inkjet ink is by means of an ink jetting technique.

A preferred ink jet head for the jetting of the pre-treatment composition printing system is a piezoelectric ink jet head. Piezoelectric inkjet jetting is based on the movement of a piezoelectric ceramic transducer when a voltage is applied thereto. The application of a voltage changes the shape of the piezoelectric ceramic transducer in the print head creating a void, which is then filled with aqueous inkjet ink. When the voltage is again removed, the ceramic expands to its original shape, ejecting a drop of pre-treatment composition from the ink jet head. However, the jetting of the ink according to the present invention is not restricted to piezoelectric inkjet printing. Other inkjet print heads can be used and include various types, such as a continuous type, a thermal print head type, a Memjet-type of head and a valve jet type.

In a preferred embodiment, the printing system may be configured to recirculate the aqueous ink prior to printing. A particularly useful inkjet head to print the aqueous inkjet inks of the ink set of the invention, is from the type that includes a recirculation of the ink within the head such as through-flow heads as disclosed in WO 2006/030235 A2 and WO 2006/064036 A1. This type of inkjet head is very suitable to be incorporated in a printing system comprising a through-flow print head having one or more nozzle for ejecting drops of aqueous ink onto a pre-treatment liquid layer, and an ink circulation system for feeding and circulating the ink through the print head, comprising an ink tank for containing the ink, a supply buffer tank for receiving the ink from the main tank and supplying the ink to the through-flow print head, a return manifold for receiving the ink from the through-flow print head and returning ink to the main ink tank via a pump.

After having applied the aqueous inkjet ink onto at least a part of the pre-treatment liquid or pre-coat layer such that an image is formed, the image is dried.

The drying step of the image can be performed by applying an air flow and or apply heating. The heating step must be performed by using heat sources; examples include equipment for forced-air heating, radiation heating such as IR-radiation, including NIR-, CIR- and SWIR radiation, conduction heating, high-frequency drying, and microwave drying. Examples of the heating process include, but are not limited to, heat press, atmospheric steaming, high-pressure steaming, and THERMOFIX. Any heat source can be used for the heating process; for example, an infrared ray lamp is employed.

### B.3. Application of the Reaction Liquid

The reaction liquid may be applied during or after the inkjet printing of the image. Preferably the reaction liquid which makes part of the ink set according to the invention, is applied onto at least a part of the image obtained by jetting the aqueous inkjet ink of § A.3. The image may be at least partially dried before applying the reaction liquid.

All well-known conventional methods can be used for coating or printing the reaction liquid onto at least a part of the image. Examples of the method include air knife coating, blade coating, roll coating, gravure coating and spraying. The advantage of the coating or printing technique is that thick reaction liquid layers in one pass of the recording medium can be obtained to assure sufficient rub resistance of the image.

The reaction liquid is preferably applied via a jetting technique which allows to apply the reaction liquid selectively onto the image. This means of applying the reaction liquid composition, which is preferably according to an image, has the advantage that the amount of required reaction liquid material is substantially lower than with the other application methods.

The jetting heads suitable for jetting the reaction liquid are the same as described in § B.1.

Finally, the applied reaction liquid is dried according to one of the ways described above for drying the pre-treatment liquid or the aqueous inkjet ink.

### C. Examples

### C.1. Materials

All materials used in the following examples were readily available from standard sources such as Aldrich Chemical Co. (Belgium) and Acros (Belgium) unless otherwise specified. Where used, water is demineralised water.
PB15:3 is Hostaperm™ B4G-KR, a C.I. Pigment Blue 15:3 pigment from CLARIANT.
Edaplan is an abbreviation used for Edaplan™ 482, a polymeric dispersant from MUNZING CHEMIE GmbH.
Proxel is a 5 wt. % aqueous solution of 1,2-benzisothiazolin-3-one available as Proxel™ K from YDS CHEMICALS NV.
Liquilube 404E is a 35 wt. % aqueous HDPE wax dispersion from Lubrizol
Carbodilite V-02 is a resin having a carbodiimide group and end-capped at both endgroups with polyethylene oxide groups and manufactured by Nisshinbo Chemical.
Carbodilite E-05 is a mixture of a resin and a dispersant, the resin having a carbodiimide group and end-capped one or both endgroups with end-capping agent different from a polyethoxylated alcohol, the dispersant is a resin having a carbodiimide group and end-capped at both endgroups with polyethylene oxide groups and manufactured by Nisshinbo
Desmodur XP2802 is a mixture of a resin and a dispersant, the resin having a carbodiimide group and end-capped one or both endgroups with end-capping agent different from a polyethoxylated alcohol according to the structure below, the dispersant is a resin having a carbodiimide group and end-capped at both endgroups with polyethylene oxide groups and manufactured by Covestro

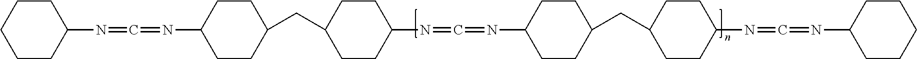

Synperonic PE P105 is a block copolymer of ethylene oxide and propylene oxide, with 50% EO and a molecular weight of 6500 from Croda GmbH
Surfynol 104PG50 is a 50 wt. % solution of 2,4,7,9-Tetramethyl-5-decyne-4,7-diol in propylene glycol from Evonik
Printrite DP379 is an aqueous 30 wt. % dispersion of a polyether based polyurethane from Lubrizol
Aquacer 530 is an aqueous dispersion containing 32 wt. % oxidized HDPE wax from BYK
Kauropal K933 is a non-ionic oxirane, mono(2-propylheptyl) ether from BASF
Tego Foamex 822 is a polyether siloxan copolymer from Evonik Mg(NO₃)₂·6H₂O is Magnesium nitrate hexahydrate from Merck Group

### C.2. Evaluation Methods

### C.2.1. Sample Preparation

The samples for the abrasion and water resistance measurements of images, are made by coating a pre-treatment liquid onto a coated corrugated liner XLHD MM X-Liner HD (180 g/m²) from MM Karton, using a 4 μm spiral bar. The coated liner was dried at 60° C. in an oven for 2 minutes.

The inkjet ink was coated onto the coated liner by using a 10 μm spiral bar. The coated inkjet ink is then dried in an oven during 5 minutes at 60° C. After drying the coated inkjet ink, the reaction liquid is coated onto the dried inkjet ink using a spiral bar of 10 μm such as to obtain a solids coverage of 0.75 g/m². The reaction liquid is dried in an oven Thermo Scientific™ Heratherm.

### C.2.2. Water Resistance

The water resistance of the samples prepared according to § C.2.1. was evaluated by measuring the CIELAB AE after wet rubbing.

The water resistance test is done according to ISO105-X12 with a Crockmeter SDL ATLAS M238AA. 0.02-0.04 ml of water is applied on top of the sample and subsequently the surface of the sample is treated with 10 double wipes using the crock meter.

The coloration of the white rubbing cloth is measured 24 h after performing the crock test, the colouration is given as AE according to the Cielab color space. The lower the ΔE values, the better the water fastness.

The evaluation of the water resistance is done according to the criteria as shown in Table 4. A good pre-treatment composition should provide excellent (0) or good (1) levels of water resistance.

TABLE 4

| Scoring | Water resistance |
|---|---|
| 0 (Excellent) | ΔE < 10 |
| 1 (Good) | 10 ≤ ΔE < 20 |
| 2 (Moderate) | 20 ≤ ΔE < 40 |
| 3 (Poor) | ΔE >= 40 |

### C.3. Preparation of the Pre-Treatment Liquid PL-1

The pre-treatment liquid PL-1 was prepared by mixing the ingredients given in Table 5. The weight percentages are relative to the total weight of the pre-treatment compositions. The raw materials were used as supplied without any further treatments.

TABLE 5
Composition of pre-treatment liquid

| Compound | Amount (wt. %) |
|---|---|
| Printrite DP 379 | 17.78 |
| Mg(NO₃)_{2•}6H₂O | 11.25 |
| Synperonic PE P105 | 1 |
| Aquacer 530 | 8 |
| Kauropal K933 | 0.04 |
| Tego Foamex 822 | 0.04 |
| 1,2-propanediol | 19 |
| 1,2-hexanediol | 2.85 |
| D.I water | 40.04 |

### C.4. Preparation of the Inkjet Ink INK-1

In a first step, a concentrated aqueous pigment dispersion was made by mixing the pigment PB15:3, with the dispersant Edaplan and 1,2 hexanediol using a Disperlux™ Yellow mixer and milled using a Dynomill™ KDL with 0.04 mm yttrium stabilized zirconium beads YTZ™ Grinding Media (available from TOSOH Corp.). After milling, the dispersion is separated from the beads. The concentrated aqueous pigment dispersion served as the basis for the preparation of the inkjet ink.

An aqueous cyan ink INK-1 was prepared by diluting the corresponding concentrated pigment dispersion with the other ink ingredients according to Table 6 expressed in wt. % based on the total weight of the ink. Water was added to complete the ink to the desired pigment concentration.

TABLE 6
Composition of inkjet ink INK-1

| Compound | Amount (wt. %) |
|---|---|
| Liquilube 404E | 2.86 |
| 1,2-propanediol | 36 |
| 1,2-hexanediol | 3.0 |
| Surfynol 104PG50 | 0.4 |
| Proxel K | 0.2 |
| PB15:3 | 3.0 |
| Edaplan 482 | 1.5 |
| D.I.water | Up to 100 wt. % |

### C.5. Preparation of the Reaction Liquid

Comparative and inventive reaction liquids were prepared by mixing the ingredients given in Table 7. The weight percentages are relative to the total weight of the pre-treatment compositions. The raw materials were used as supplied without any further treatments.

TABLE 7
Composition of comparative and inventive rection liquids

| | Amount (wt. %) | | | | | |
|---|---|---|---|---|---|---|
| Compound | COMP-V1 | INV-V1 | INV-V2 | COMP-V2 | INV-V3 | INV-V7 |
| Carbodilite V-02 | 15.00 | — | — | 30.00 | — | — |
| Carbodilite E-05 | — | 14.53 | — | — | 29.06 | — |
| Desmodur XP2802 | — | — | 13.70 | — | — | 27.4 |
| Propyleneglycol | 35.5 | 35.5 | 35.5 | 35.5 | 35.5 | 35.5 |
| Byk333 | 0.75 | 0.75 | 0.75 | 0.75 | 0.75 | 0.75 |
| D.I. Water | Up to | Up to | Up to | Up to | Up to | Up to |
| | 100 wt. % | 100 wt. % | 100 wt. % | 100 wt. % | 100 wt. % | 100 wt. % |

### C.6. Example 1

Comparative and inventive ink sets for inkjet printing were assembled by combining the above prepared pre-treatment liquid PL-1, the above prepared inkjet ink INK-1 together with the respective comparative and inventive reaction liquids from. Samples were prepared by coating the comparative and inventive ink sets on a recording medium as described in § C.2.1.

Water resistance of the printed images were measured as described in § C.2.2. The measured values are listed in Table 8.

TABLE 8
Water resistance of printed images with inventive
and comparative reaction liquids.

| Reaction liquid | Water resistance |
|---|---|
| COMP-V1 | 3 |
| INV-V1 | 0 |
| INV-V2 | 2 |
| COMP-V2 | 3 |
| INV-V3 | 0 |
| INV-V4 | 2 |

From Table, it can be concluded that an ink set including an aqueous ink and a reaction liquid comprising a carbodiimide according to Formula I or II do lead to printed images showing an improved water resistance.

1-13. (canceled)

14. An ink set for inkjet printing comprising an ink and an aqueous reaction liquid, wherein (a) the ink comprises water and a pigment and (b) the aqueous reaction liquid comprises (i) a dispersant and (ii) a polycarbodiimide according to Formula I, II, III or IV or a carbodiimide according to Formula V or VI, 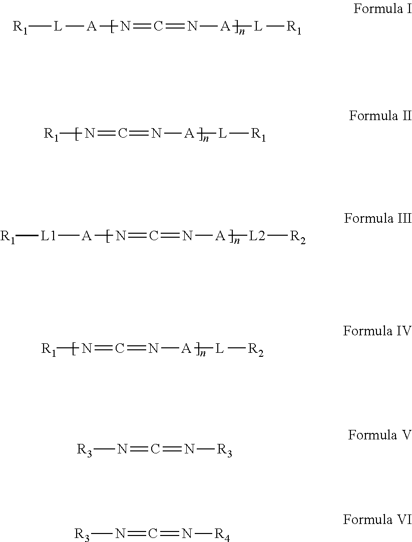
wherein
A is a group of atoms present between two isocyanate groups in a diisocyanate or polyisocyanate used in the preparation of the polycarbodiimide,
each of L, L1, and L2 independently is a divalent linking group selected from the group consisting of a substituted and unsubstituted urethane, a substituted and unsubstituted urea, a substituted and unsubstituted 2-oxazolidone, a substituted and unsubstituted carbodiimide, a substituted and unsubstituted amide, a substituted and unsubstituted acyl urea, and a substituted and unsubstituted biuret,
each of R₁ and R₃ independently is an unsubstituted alkyl group, unsubstituted alkenyl group, unsubstituted alkynyl group, unsubstituted aryl or heteroaryl group, unsubstituted aralkyl group, unsubstituted alkaryl group, or unsubstituted cycloalkyl group,
each of R₂ and R₄ independently is a substituted or unsubstituted alkyl group, a substituted or unsubstituted alkenyl group, a substituted or unsubstituted alkynyl group, a substituted or unsubstituted aryl or heteroaryl group, a substituted or unsubstituted aralkyl group, a substituted or unsubstituted alkaryl group, or a substituted or unsubstituted cycloalkyl group, and
n is an integer of 1 or higher.

15. The ink set of claim 14, wherein A is selected from a group consisting of isophorone, 4,4′-dicyclohexylmethane, 2,4,4′-trimethyl-1,6-hexamethylene, hexamethylene, pentamethylene, tolylene, xylene, m-tetramethylxylene, and diphenylmethane.

16. The ink set of claim 14, wherein the dispersant is a water-soluble copolymer selected from the group consisting of a PPO/PEO copolymer, an arylethylphenyl polyglycol ether, fatty acid derivatives with EO/PO moieties, and a polycarbodiimide having a structure wherein the isocyanate groups at the endgroups are end-capped by means of a hydrophilic group.

17. The ink set of claim 14, wherein the reaction liquid comprises a polyether siloxane surfactant.

18. The ink set of claim 16, wherein the reaction liquid comprises a polyether siloxane surfactant.

19. The ink set of claim 14, wherein the ink comprises a dispersant comprising anionic groups.

20. The ink set of claim 16, wherein the ink comprises a dispersant comprising anionic groups.

21. The ink set of claim 14, wherein the ink comprises a pigment which is encapsulated by means of a cross-linked polymeric shell.

22. The ink set of claim 16, wherein the ink comprises a pigment which is encapsulated by means of a cross-linked polymeric shell.

23. The ink set of claim 18, wherein the ink comprises a pigment which is encapsulated by means of a cross-linked polymeric shell.

24. The ink set of claim 14, wherein the ink comprises a water soluble organic solvent.

25. The ink set of claim 14, wherein the ink further comprises a resin particle, and wherein the resin is selected from the group consisting of a polyacrylate containing resin, a polyurethane containing resin, and a wax.

26. The ink set of claim 14, further comprising a pre-treatment liquid comprising a fixing agent selected from the group consisting of a multivalent salt, a cationic polymer, and an organic acid.

27. The ink set of claim 16, further comprising a pre-treatment liquid comprising a fixing agent selected from the group consisting of a multivalent salt, a cationic polymer and an organic acid.

28. The ink set of claim 18, further comprising a pre-treatment liquid comprising a fixing agent selected from the group consisting of a multivalent salt, a cationic polymer and an organic acid.

29. A recording method comprising the following step:
a) jetting the ink as defined in claim 14 onto a recording region of a substrate,
b) optionally at least partially drying the jetted ink by applying heat or an air flow to the region,
c) adhering the reaction liquid as defined in claim 14 to at least a part of the recording region, and
d) drying the aqueous reaction liquid by applying heat or an air flow to the recording region.

30. The recording method of claim 29, wherein prior to step a), a pre-treatment liquid comprising a fixing agent selected from the group consisting of a multivalent salt, a cationic polymer, and an organic acid is adhered to the substrate.

31. The recording method of claim 30, wherein the pre-treatment liquid is adhered by means of a jetting method.

32. The recording method of claim 31, wherein the pre-treatment liquid is at least partially dried by applying heat or an air flow to the liquid.

33. The recording method of claim 30, wherein the pre-treatment liquid is at least partially dried by applying heat or an air flow to the liquid.
